(19) United States
(12) Patent Application Publication
(10) Pub. No.: US 2007/0293063 A1
(43) Pub. Date: Dec. 20, 2007

(54) Connector and Connector Assembly Comprising Leads with at Least One Opening

(76) Inventors: Gert Droesbeke, Geel-Belgium (BE); Tiny Peters, Zeeland (NL); Paulus J. J. M. Pigmans, Tilburg (NL)

Correspondence Address: BANNER & WITCOFF, LTD.;ATTORNEYS FOR CLIENT NO. 005222, 10 S. WACKER DRIVE, 30TH FLOOR, CHICAGO, IL, 60606, US

(21) Appl. No.: 11/662,557

(22) PCT Filed: Jul. 11, 2005
(86) PCT No.: PCT/EP05/07491

§ 371 Date: Mar. 12, 2007

(30) Foreign Application Priority Data
Sep. 15, 2004 (NL) 1027044

(51) Int. Cl. H01R 13/648

(52) U.S. Cl. 439/108

(57) ABSTRACT

The invention relates to a connector including a plurality of leads extending between a mating end (M) and a contact end (C) of said connector and a further part contacting at least one of said leads by at least one contacting element. At least one of said leads forms a portion of at least one opening holding said contacting element of said further part. Preferably the opening is formed with the at least one lead. Such an opening reduces the influence of the contacting element on the differential impedance.

The invention relates to a connector comprising a plurality of leads extending between a mating end and a contact end of said connector and a further part contacting at least one of said leads by at least one contacting element.

EP-A 1 107 387 discloses a connector comprising an insulating housing, a plurality of contact elements arranged in rows and columns in said housing and at least one shielding plate arranged between adjacent columns of contact elements. The shielding plate is a structurally separate part provided with fastening means and is attached only to one of the contact elements of a column of contacts by means of the fastening means.

A drawback of the prior art is that the fastening means influences the differential impedance of the connector

It is an object of the invention to provide a connector that may contact a further part with less influence on the differential impedance of the connector.

This object is achieved by providing a connector characterized in that at least one of said leads forms a portion of at least one opening holding said contacting element of said further part. Preferably, the opening is formed within the at least one lead. The differential impedance is determined by the size of the signal leads and the distance to one another and the ground lead. It also depends on the dielectric constant of the medium. As the contacting element is preferably no longer provided between the leads of the connector but within a lead, the influence on the differential impedance of the connector is reduced.

In an embodiment of the invention, the further part is a shielding plate with at least one contacting element having a distal portion and an intermediate portion extending between said shielding plate and said distal portion and wherein said distal portion has a deformable structure for engaging a portion of a ground lead. The one or more holes in the ground lead of the connector constitutes an easy and reliable way to attach the shielding plate to form the connector. Preferably, the deformable structure comprises a first leg and a second leg extending in a longitudinal direction from said contacting element and said first leg and said second leg are bent outwardly and meet at an end portion such that an opening is formed between said first leg and second leg. Such eye of the needle press fit connection means forms a reliable and easy connection for the shielding plate to the ground lead. Alternatively, the deformable structure comprises two outwardly extending wings shaped to spread in the hole in the ground lead to provide a reliable connection between the ground lead and the shielding plated.

In an embodiment of the invention the hole is provided at the contact end of a ground lead. Preferably the ground lead is broader at said contact end than at said mating end, since a broader ground lead provides a better location for the hole while near the contact end typically the distance between the leads may be larger than at the mating end for a high density connector.

In an embodiment of the invention the connector comprises an insulating housing module and a shielding plate with a planar portion and one or more shielding flanges extending from said planar portion and abutting against one or more walls of said insulating housing module. These shielding flanges partly encapsulate the insulating housing module and accordingly ensure that the differential impedance of the connector is only determined by the signal leads, the ground lead and the shielding plate of the connector.

The invention also relates to a connector assembly comprising a plurality of stacked connectors, wherein each of said connectors comprises a substantially aligned series of leads extending between a mating end and a contact end of said connector and for each connector at least one lead comprises a hole to receive at least one contacting element to contact at least one lead of an adjacent connector. The provision of a hole in at least one lead of each of a series of stacked connectors provides several grounding and/or stacking advantages.

In one embodiment said holes are aligned and said contacting element is inserted through a plurality of said aligned holes. Accordingly, one contacting element in the form of e.g. a rod can be used to cross-connect adjacent leads of the series of stacked connectors. To ensure an adequate contact, said contacting element preferably has a series of deformable structures in a longitudinal direction of said contacting element and said holes have different diameters for engaging with respective deformable structures on said contacting element. In a perfectly matched assembly, the deformable structures preferably have different dimensions decreasing in size along said longitudinal direction such that the deformable structure is fit to interact with the corresponding hole in the direction of insertion. To provide a single, rod like, contacting element, in the case of stacked connectors with shielding plates, preferably one or more of said shielding plates comprises one or more holes for insertion of said contacting element.

In an embodiment of the invention said conductors are stacked and each of said connectors comprises a shielding plate with at least one contacting element with a distal portion and an intermediate portion extending between said shielding plate and said distal portion wherein said distal portion has a deformable structure for engaging a portion of a ground lead. Preferably, said deformable structure comprises a first leg and a second leg extending in a longitudinal direction from said contacting element and wherein said first leg and said second leg are bent outwardly and meet at an end portion such that an opening is formed between said first leg and second leg. Accordingly a stack of connectors with shielding plates is provided wherein the shielding plates are attached to the ground lead with press fit connections.

Preferably, the contacting element comprises a bent section. The bent section of the contacting elements allows stacking of the connectors such that they are right on top of each other.

In an embodiment of the invention, said connector assembly is part of a cable connector further comprising a housing and said contacting element contacts said housing. Accordingly, a cable connector of increased shielding performance is provided since a braid of the cable for the cable connector can be connected via other components of the cable connector, such as a ferrule portion, to the housing and accordingly to the ground leads of the stacked connectors.

The invention will be further illustrated with reference to the attached drawings, which schematically show preferred embodiments according to the invention. It will be understood that the invention is not in any way restricted to these specific and preferred embodiments.

In the drawings:

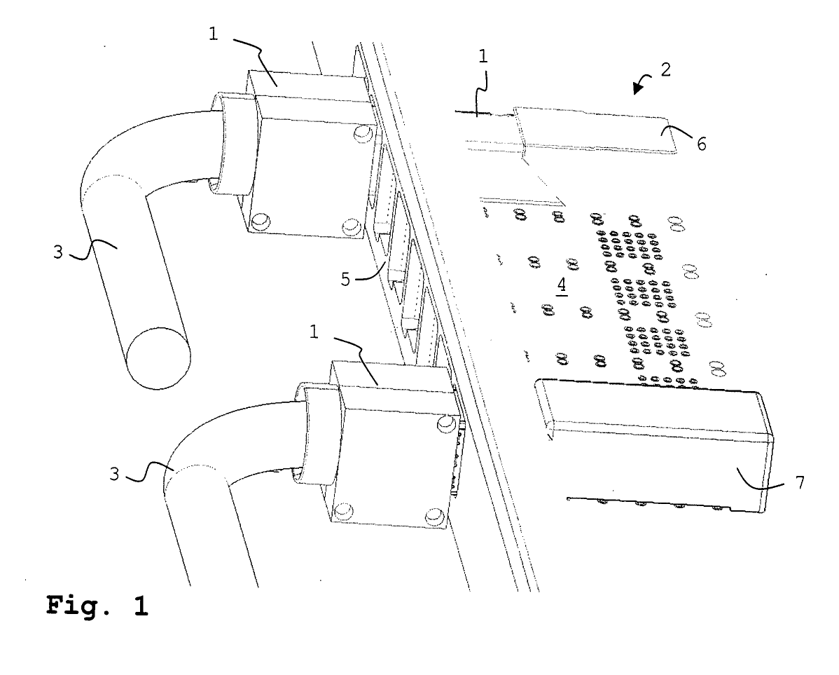

FIG. 1 displays a connector system according to an embodiment of the invention;

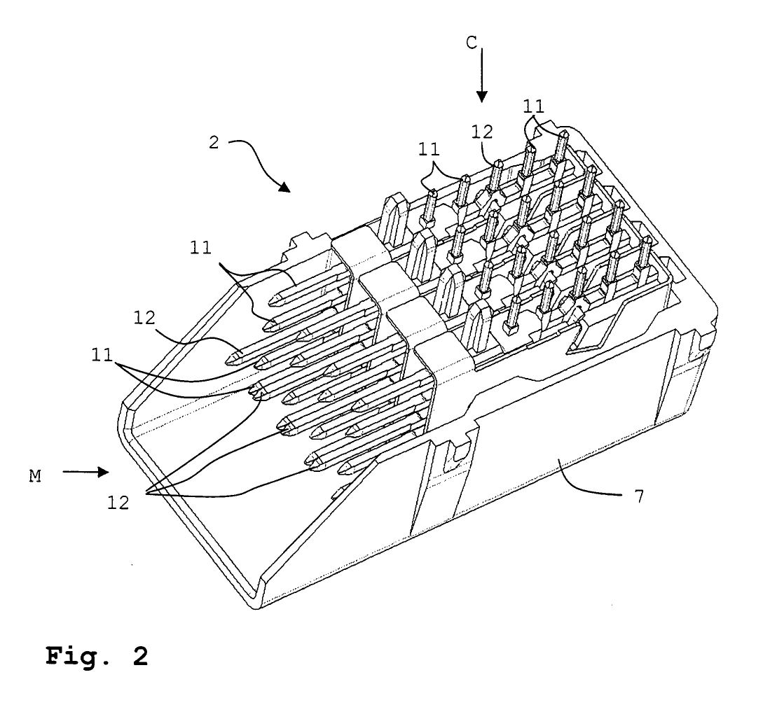

FIG. 2 shows a connector assembly according to an embodiment of the invention;

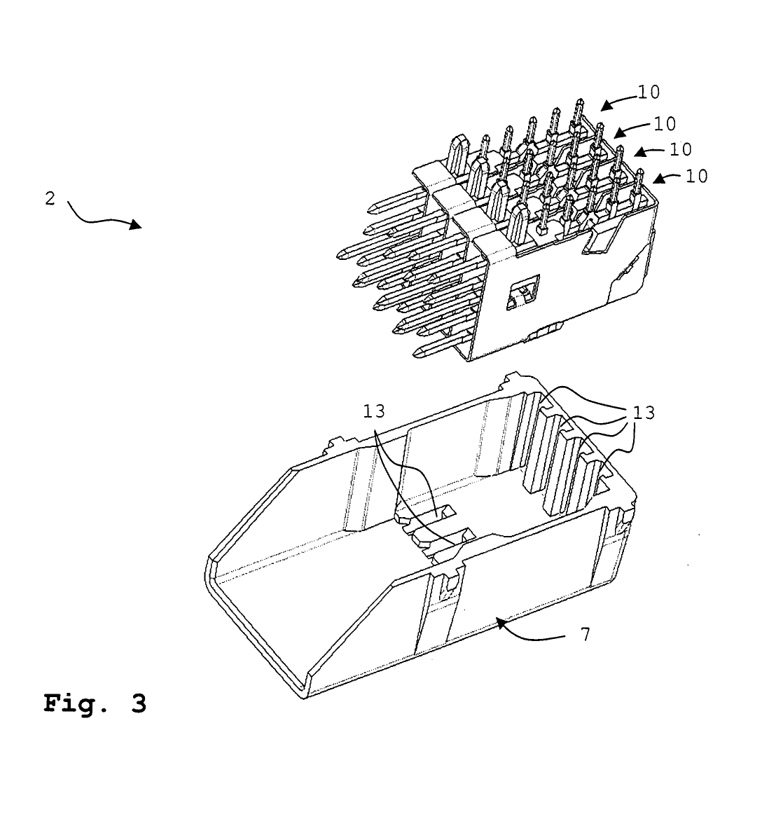

FIG. 3 shows the connector assembly of FIG. 2, wherein the retainer and a plurality of connectors according to an embodiment of the invention are separated;

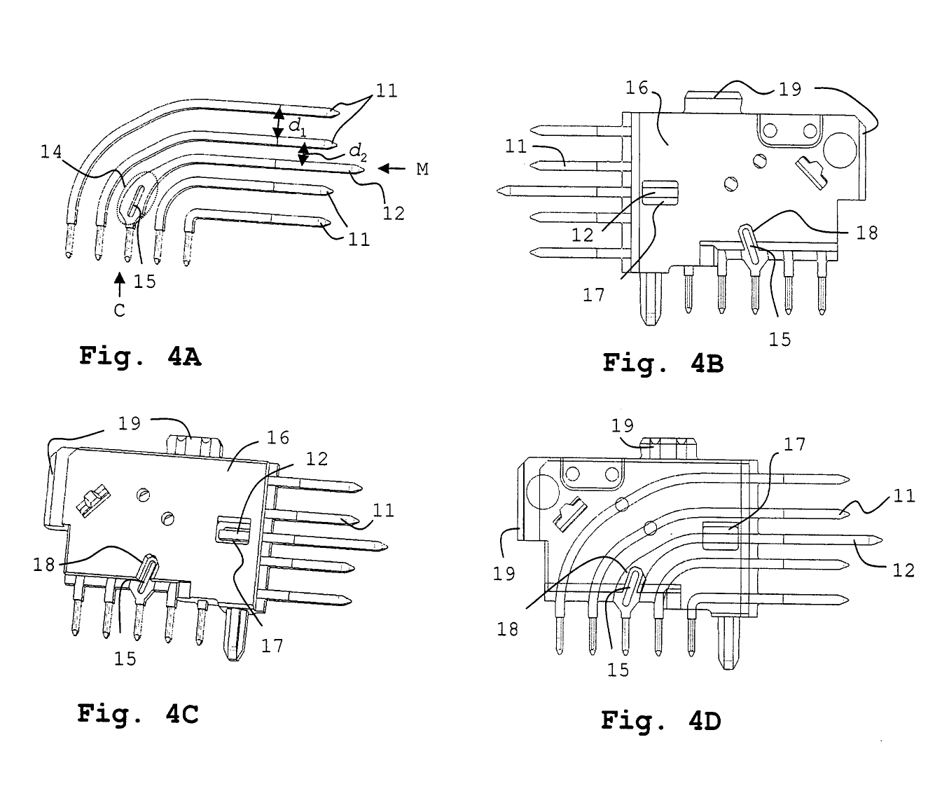

FIGS. 4A-4D display several views of several components of a single connector of the plurality of connectors shown in FIG. 3 without a shielding plate;

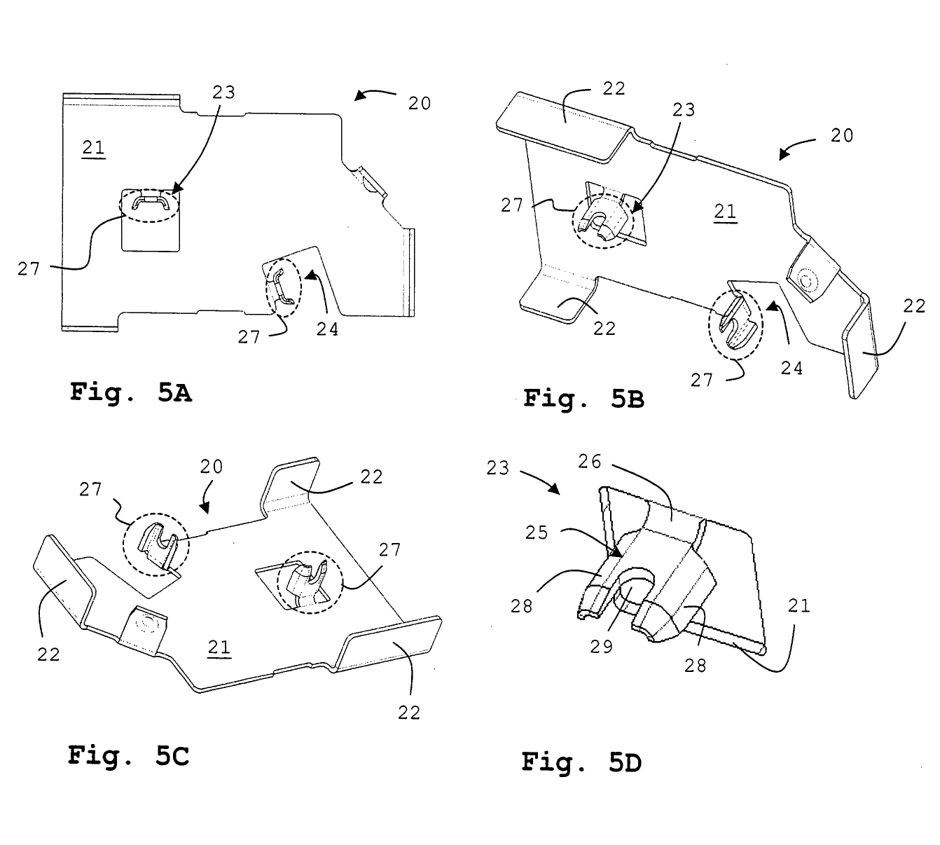

FIGS. 5A-5D display several views of the shielding plate for the connector of FIGS. 4A-4D,

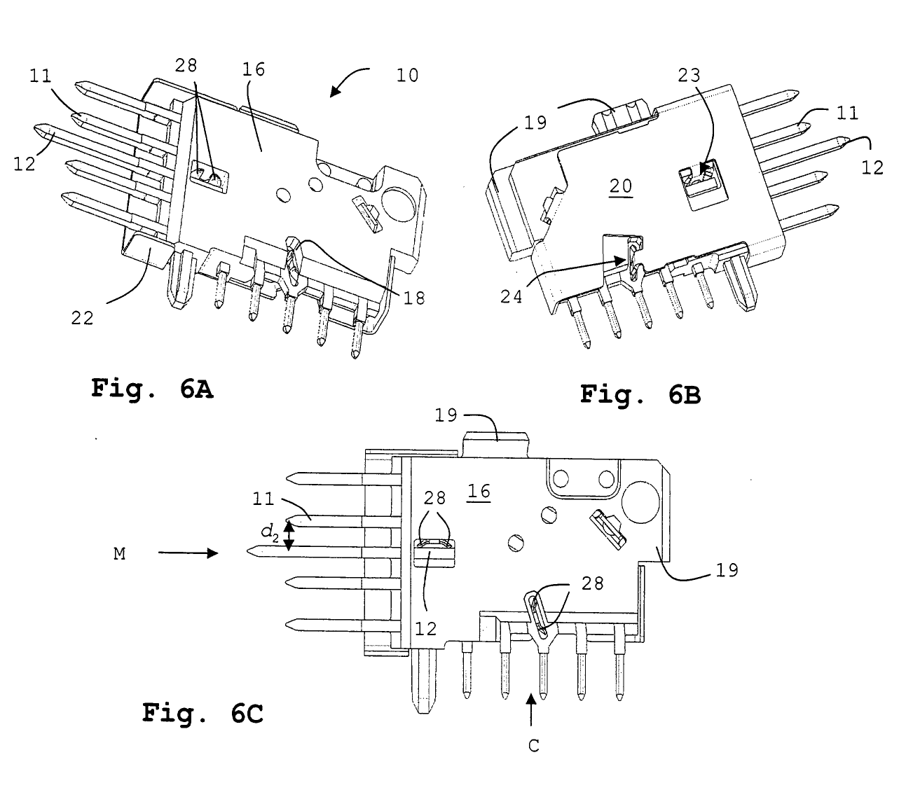

FIGS. 6A-6C display several views of an assembled connector according to an embodiment of the invention.

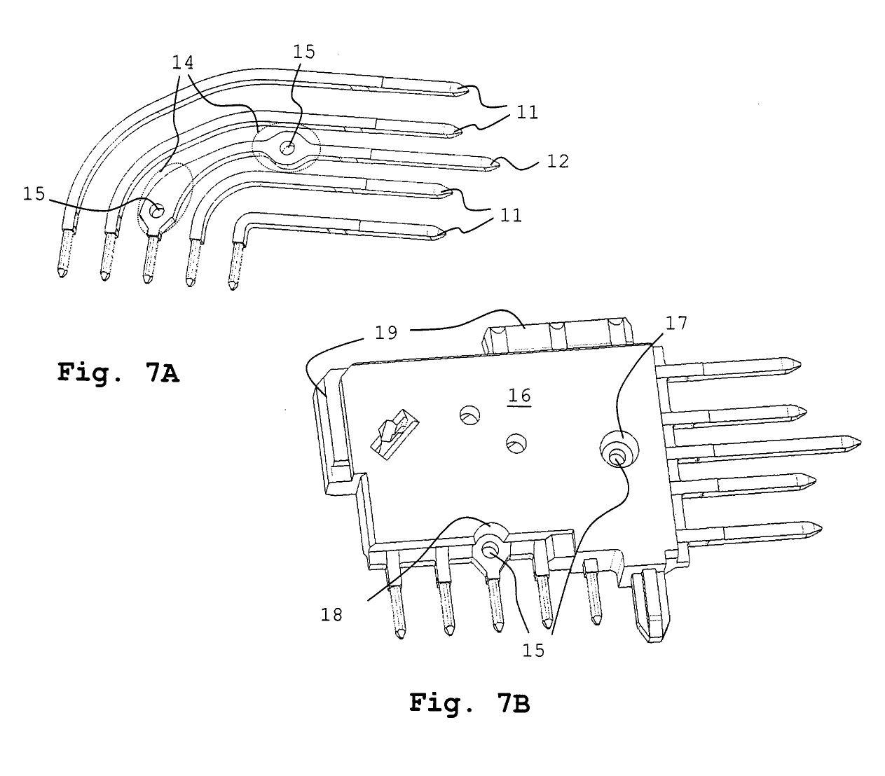

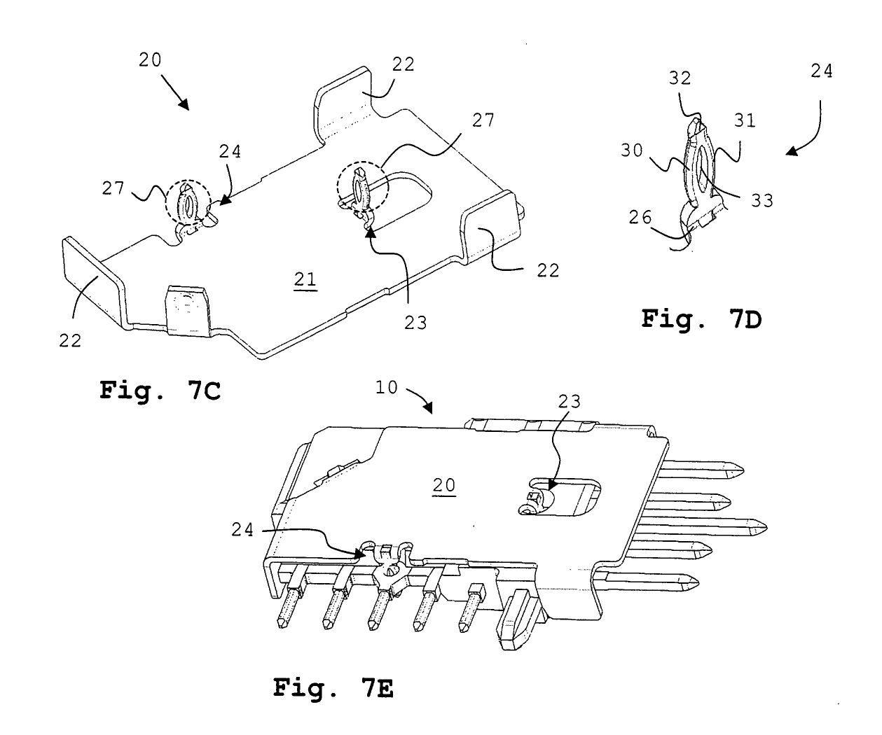

FIGS. 7A-7E display several views of several components of a single connector;

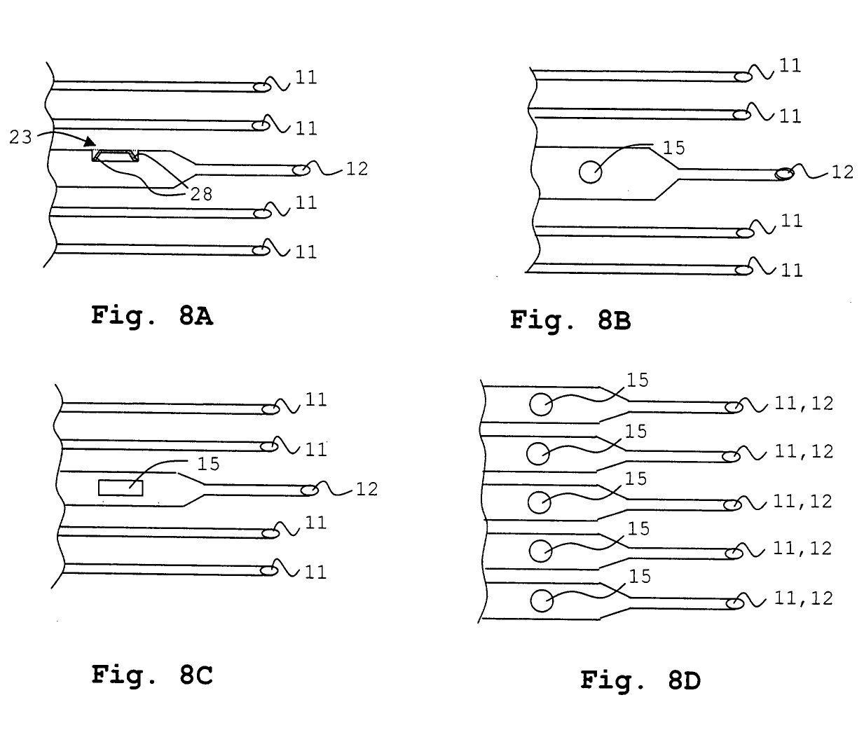

FIGS. 8A-8D show lead arrangements with several types of openings according to embodiments of the invention;

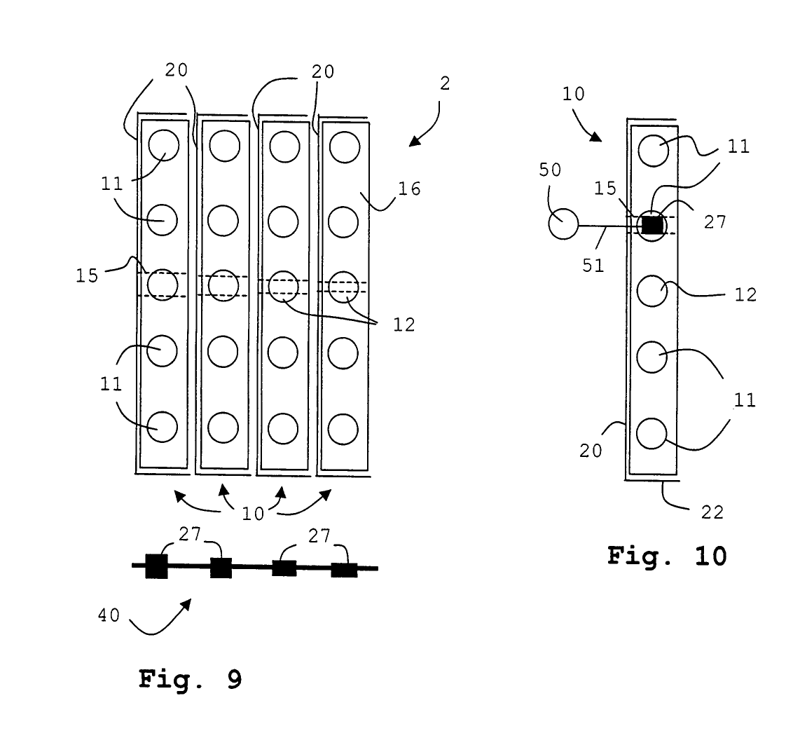

FIG. 9 shows a connector assembly according to an embodiment of the invention;

FIG. 10 shows a connector according to an embodiment of the invention, and

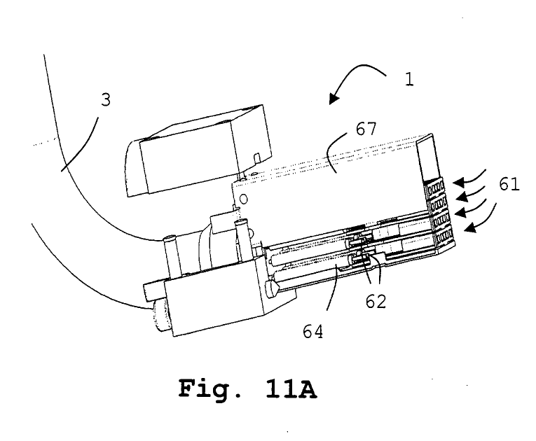

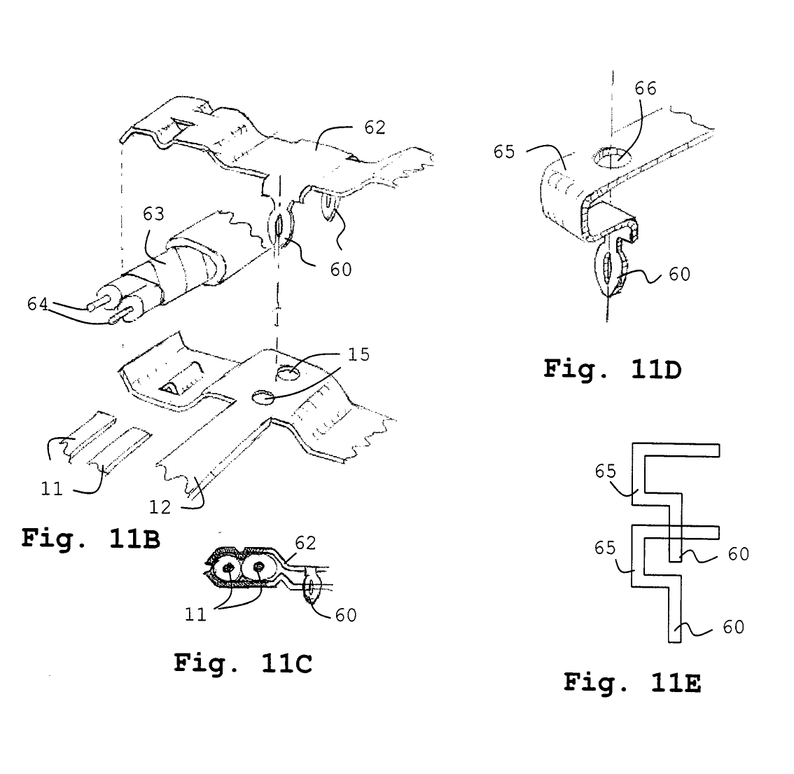

FIGS. 11A-11E show a cable connector comprising a cable connector assembly according to an embodiment of the invention and detailed views of parts of the cable connector.

In FIG. 1 a high density connector system is displayed, wherein a cable connector 1 and a board connector assembly 2 provide an electrical connection of wires (not shown) of a cable 3 to components (not shown) on a circuit board 4. The cable connector 1 comprises a diecast base section, a diecast housing part and a sheet metal housing part as described in WO2004/057707 which is herewith incorporated by reference in the present application for the further description of these housing parts. The cable connector 1 can be inserted in a panel 5. The board connector assembly 2 includes a retainer 6 and may be covered be a shielding cage 7. This shielding cage has been previously described in WO2004/057709 and is herewith incorporated by reference in the present application.

FIGS. 2 and 3 show the connector assembly 2 of FIG. 1 according to an embodiment of the invention. The connector assembly 2 comprises a plurality of right-angled connectors 10 each having signal leads 11 and a ground lead 12 arranged in a column and extending between a mating end M and a contact end C. At the contact end the leads are formed as solder tails to enable connection with the circuit board 4. The signal leads 11 and ground lead 12 at the mating end M are arranged to contact the cable connector 1. The retainer 7 comprises slots 13 to hold the connectors 10.

FIGS. 4A-4D display several views of several components of a connector 10 of the plurality of connectors shown in FIGS. 2 and 3.

FIG. 4A displays high density right-angled conducting leads or terminals forming the signals leads 11 and the ground lead 12. The lead spacing d₁ at the mating end M is 1.5 mm between respective signal leads 11 and the lead spacing d₂ between the ground lead 12 and the adjacent signal lead 11 is 1.1 mm. At the contact end C the lead spacing requirements are less severe. Accordingly, the ground lead 12 has a broader portion 14 near the contact end C wherein a hole 15 is provided.

FIGS. 4B-4D show several views of the lead assembly accommodated in an insulating housing module 16, e.g. an insert moulded lead frame assembly (IMLA). In FIG. 4D the copper alloy leads 11, 12 are drawn visibly for clarity purposes although in practice they would almost always be obscured by the plastic housing module 16. The insulating housing module 16 holds the leads 11, 12 in position.

The insulating housing module 16 has an opening 17 giving access to the space between the ground lead 12 and an adjacent signal lead 11. Further, the insulating housing module has a recess 18 enabling full access to the hole 15 in the ground lead 12 near the contact end C. The opening 17 and recess 18 are preferably located such that access to the ground lead is provided near the mating end M respectively the contact end C. The insulating housing module 16 may comprise other holes or recesses. Finally, the insulating housing module 16 comprises extensions 19 adapted to cooperate with the recesses or slots 13 of the retainer 7 as shown in FIG. 3. Consequently, the connectors 10 can be hold by the retainer 7.

FIGS. 5A-5D display a shielding plate 20 in various views. The shielding plate 20 has the function to reduce the influence of external noise sources on the quality of the signal The shielding plate 20 is metallic and comprises a planar portion 21 and shielding flanges 22 extending from the sides of the shielding plate 20 away from the planar portion 21. The shielding flanges 22 enable control of the differential impedance of the connector 10.

Further, the shielding plate 20 has a first connection element 23 and a second connection element 24 extending in the same direction as the shielding flanges 22. Each of the connection elements 23, 24 comprises a distal portion 25 and an intermediate portion 26 extending between the planar portion 20 and the distal portion 25. The distal portions 25 comprise a deformable structure 27. The deformable structure 27 comprises wings 28 and a gap 29 in the embodiment of FIG. 5D. The backside of the deformable structure 27 abutting against the insulating housing 16 has a larger surface to distribute forces over the larger area in order not to damage the housing 16. On the other hand, the side of the deformable structure 27 facing the ground lead 12 has a small area to have a large contact force per unit area. The openings in the planar portion 21 were found to be only of negligible influence for the electromagnetic shielding performance of the connector 10.

FIGS. 6A-6C depict the connector 10 having a shield plate 20 connected according to an embodiment of the invention. The connection elements 23, 24 are respectively inserted in the opening 17 of the insulating housing module 16 and the hole 15 of the ground lead 12 to engage a portion of the ground lead 12. During this insertion, the wings 28 of the fastening element 23 spread along the upper side of the ground lead 12 in the direction of the ground lead 12 as a result of interaction with the insulating housing module 16 at the opening 17 and forms a press fit connection. On the other hand, the wings 28 of the connection element 24 spread gradually in the elongated hole 15 of the ground lead 12 to form a press fit connection. Accordingly, the shielding plate 20 is reliably and easy attached to the insulating housing module 16 to form the connector 10 while the lead distance d₂, defined in FIG. 4A, is reduced. As the connection of the shielding plate 20 to the ground lead 12 is provided near the mating end M and the contact end C, respectively the return current in the shielding plate 20 is substantially parallel to the current in the signal leads 11 which is advantageous for the performance of the connector 10.

The shielding flanges 22 abut the walls of the insulating housing module 16. Accordingly, the differential impedance of each connector 10 can be adequately controlled.

For the connector assembly 2, shown in FIGS. 2 and 3, a plurality of connectors 10 as shown in FIGS. 6A-6C are positioned adjacent to each other to form a matrix of signal leads 11 and ground leads 12 wherein each column of leads is separated by a shielding plate 20.

FIGS. 7A-7E display several views of several components of a single connector 10. Identical reference numbers indicate identical or similar parts of the connector 10.

Again, FIG. 7A displays a lead frame with signal leads 11 and a ground lead 12. In contrast to FIG. 4A, the ground lead 12 now comprises holes 15 near the mating end M and the contact end C. The openings or holes 15 shown here have a more circular shape in broadened sections 14 of the ground lead 12. The insulating housing module 16 has a corresponding opening 17 and recess 18 to provide access to the holes 15 in the ground lead 12.

The connection means 23, 24 in FIGS. 7C and 7D comprise an intermediate portion 26 and a deformable structure 27. The deformable structure 27 has a first leg 30 and a second leg 31 extending in a longitudinal direction from said contacting elements 23, 24. The first leg 30 and second leg 31 are bent outwardly and meet at an end portion 32 such that an opening 33 is formed between the first leg 30 and second leg 31. Accordingly, the deformable structure 27 can be described as an eye of the needle type structure. When the deformable structures 27 are inserted in the openings 15 of FIG. 7A and 7B, the legs 30, 31 are forced inwardly an provide a press fit connection of the shielding plate 20 to the ground lead 12 as shown in FIG. 7E. The differential impedance of the connector 10 is not disturbed by the attached shielding plate since the connection means 23, 24 are not between the ground lead 12 and an adjacent signal lead 11.

FIGS. 8A-8D show lead arrangements with several types of openings according to embodiments of the invention

In FIG. 8A a lead frame is shown, wherein the ground lead 12 has a cut out part to form a portion of an opening for holding the distal portion 25 of the contacting element 23. The cut out part forms an irregularity on the ground lead 12 and influences the differential impedance. The wings 28 of the contacting element 23 may spread in the cut out part of the ground lead 12 by interaction with the insulating housing module 16 (not shown for clarity purposes in FIG. 8A) to obtain a reliable connection.

In FIG. 8B, the ground lead 12 has a circular hole 15 to hold the eye of the needle type distal portion of contacting element 24. The boundaries of the ground lead 12 are left intact and accordingly do not influence the differential impedance. The ground lead 12 is broadened to some extent to accommodate the hole 15. As an example the broad section in the ground lead 12 in FIG. 8B may measure 1.3 mm, whereas the broad section of FIG. 8B may measure 0.7 mm. Accordingly, the lead configuration of FIG. 8B is 0.6 mm wider than for the configuration of FIG. 8A.

In FIG. 8C, the opening 15 is a rectangular slot with the long dimension parallel to the longitudinal axis of the ground lead 12. Other shapes for the opening 15 are envisaged, such as an oval.

In an application, all leads are provided with an opening or form a part of an opening 15, 17. For instance, if an insulating housing module 16 comprises five leads, all five leads can be provided with an opening 15, as shown in FIG. 8D. If no shielding plate 20 is connected, all five leads can be used for carrying low frequency signals, i.e. all leads qualify as signal leads 11. If a shielding plate 20 is connected the operator may choose which openings 15 are used for holding the contacting element or elements 23, 24, 50. Accordingly, e.g. a coaxial structure or a twinaxial structure can be obtained. For a coaxial structure, the contacting elements are held by openings 15 in every other lead 12, whereas for a twinaxial structure the centre lead 12 is contacted. It is noted that other configurations with more or less than five leads are envisaged as well.

Another application is shown in FIG. 9, wherein a front view of a connector assembly 2 with signal leads 11 and a ground lead 12 are schematically displayed. Each of the ground leads comprises a hole 15, indicated by the dashed lines. The holes 15 of the connectors 10 of the assembly 2 are aligned such that a single contacting element 40 can be inserted. The contacting element 40 has a series of deformable structures 27 in a longitudinal direction of said contacting element and the holes 15 preferably may have different diameters for engaging with respective deformable structures 27 on the contacting element 40. The deformable structures 27 preferably may have different dimensions decreasing in size along said longitudinal direction. In this manner, leads within the connector, for example ground leads, can be electrically commoned if desirable.

The assembly 2 may further comprise a plurality of shielding plates 20 located between adjacent connectors 10. The shielding plates 20 also comprise holes for insertion of the contacting element 40.

FIG. 10 shows an embodiment of the invention wherein a signal lead 11 comprises a hole 15, indicated by the dashed line to contact a further electrical conductor 50 by insertion a contacting element 51 in said hole 15. Accordingly, an electrical signal can be monitored or tapped from the signal lead 11.

FIGS. 11A-11E schematically illustrate a cable connector 1 and components thereof as displayed in FIG. 1. Terminal blocks 61 are stacked and each may comprise a metallic plate 62 having shaped to form a wire management comb as shown in FIG. 11B. The fingers of the wire management comb can engage the shielding braids 63 of the twinax wires 64 for grounding to the ground lead 12. The wire management comb may be a separate element or part of a shielding plate 20 and may, for example, be formed along the edge of a shield adjacent the back end of the terminal block 61

The plates 62 comprise contacting elements 60 with a deformable structure for engaging a ground lead 12 of an adjacent terminal block connector. Again, the contacting elements may be of the eye of the needle type as shown in FIGS. 11B-11D.

FIG. 11C shows a part of the wire comb in an attached state. Accordingly, the wires 64 are positioned and the foil 63 is engaged by the press fit connection obtained by holding the contacting elements 60 in the openings 15 of the ground lead 12.

Since several terminal blocks 61 are stacked, the contacting element 60 comprises a bent section 65 provided with another hole 66, as shown in FIG. 11D. The bent section 65 of the contacting elements 60 allows stacking of the connectors 10 right on top of each other as shown in FIG. 1lE. The stacked terminal blocks 61 are part of the cable connector 1 that further comprises a housing 67 and said contacting element 60 contacts said housing. Accordingly, the contacting element 60 provides improved stacking and electromagnetic shielding performance.

It should be noted that the embodiment of the connector described above does not limit the scope of the invention; further modifications are possible such as other deformable structures 27 at the distal portion 25 of the connection elements 23, 24. The contacting elements can also be used for electrically connecting various leads 11, 12. Reasons for linking lead include power distribution, in which one lead is sacrificed in order to take the arc over when plugging the connector in a powered state or where several beams are used to get an equal spread of the required amount lead material to handle the power. Another application of linking lead may be high frequency and differential signal distribution where leads may be dedicated for the ground return current. In the case of high frequency applications, the openings in the shielding plates for providing the contacting elements are preferably located at the ground leads in order to minimize openings in the region of the signal leads and therefore crosstalk.

1. A connector comprising a plurality of leads extending between a mating end (M) and a contact end (C) of said connector and a further part contacting at least one of said leads by at least one contacting element characterized in that at least one of said leads forms a portion of at least one opening holding said contacting element of said further part.

2. The connector according to claim 1, wherein the opening is formed within the at least one lead.

3. The connector according to claim 1, wherein said further part is a shielding plate with at least one contacting element having a distal portion and an intermediate portion extending between said shielding plate and said distal portion and wherein said distal portion has a deformable structure for engaging a portion of a ground lead.

4. The connector according to claim 3, wherein said deformable structure comprises a first leg and a second leg extending in a longitudinal direction from said contacting element and wherein said first leg and said second leg are bent outwardly and meet at an end portion such that an opening is formed between said first leg and second leg.

5. The connector according to claim 3, wherein said deformable structure comprises two outwardly extending wings spreading in said hole.

6. The connector according to claim 1, wherein said opening is provided at the contact end (C) of a ground lead.

7. The connector according to claim 6, wherein said ground lead has a broadened portion at said contact end (C).

8. The connector according to claim 1, wherein said connector comprises an insulating housing module and a shielding plate with a planar portion m and one or more shielding flanges planar portion and one or more shielding flanges extending from said planar portion and abutting against one or more walls of said insulating housing module.

9. The connector according to claim 1, wherein said opening is provided in a signal lead and said further part comprises a further electrical conductor contacting said signal lead via said contacting element.

10. A connector assembly comprising a plurality of stacked connectors, wherein each of said connectors comprises a substantially aligned series of leads extending between a mating end (M) and a contact end (C) of said connector and for each connector at least one of said leads forms a portion of at least one opening holding said contacting element to contact at least one lead of an adjacent connector.

11. The connector assembly according to claim 10, wherein the opening is formed within the at least one lead.

12. The connector assembly according to claim 10, wherein said openings are aligned and said contacting element is inserted through a plurality of said aligned holes.

13. The connector assembly according to claim 12, wherein said contacting element has a series of deformable structures in a longitudinal direction of said contacting element and said openings are of different sizes for engaging with respective deformable structures on said contacting element.

14. The connector assembly according to claim 13, wherein said deformable structures have different dimensions decreasing in size along said longitudinal direction.

15. The connector assembly according to claim 10, wherein said assembly further comprises a plurality of shielding plates located between adjacent leads and one or more of said shielding plates comprises one or more holes for insertion of said contacting element.

16. The connector assembly according to claim 10, wherein said connectors are stacked and wherein each of said connectors comprises a shielding plate with at least one contacting element with a distal portion and an intermediate portion extending between said shielding plate and said distal portion wherein said distal portion has a deformable structure for engaging a portion of a ground lead.

17. The connector assembly according to claim 16, wherein said deformable structure comprises a first leg and a second leg extending in a longitudinal direction from said contacting element and wherein said first leg and said second leg are bent outwardly and meet at an end portion such that an opening is formed between said first leg and second leg.

18. The connector assembly according to claim 16, wherein said contacting element comprises a bent section.

19. The connector assembly according to claim 16, wherein said connector assembly is part of a cable connector further comprising a housing and said contacting element contacts said housing.

20. The connector according to claim 1, wherein said at least one lead is within a body of insulating material and said opening is bounded in part on one side by the insulating material and bounded in part on an opposed side by the lead.
